(19) United States
(12) Patent Application Publication
(10) Pub. No.: US 2006/0143969 A1
(43) Pub. Date: Jul. 6, 2006

(54) Adjustable stake for a decoy

(76) Inventor: Glenn Lindaman, Whitehall, PA (US)

Correspondence Address: DUANE MORRIS, LLP;IP DEPARTMENT, 30 SOUTH 17TH STREET, PHILADELPHIA, PA, 19103-4196, US

(21) Appl. No.: 11/268,143

(22) Filed: Nov. 7, 2005

Related U.S. Application Data
(60) Provisional application No. 60/625,319, filed on Nov. 5, 2004.

(51) Int. Cl. A01M 31/06

(52) U.S. Cl. 43/2

(57) ABSTRACT

A hunting decoy, for example simulating a wild turkey, is structured for lifelike motion in the field, and can be quickly deployed and adjusted in height. In one arrangement, freedom of body and head movement is provided to simulate natural movement in a limited range. Spring mounts including helical spring couplings between a vertical post and the dorsal part of a torso portion of the body, and also between the vertical post and a head/neck diverted support. These couplings allow the body and the head to move relative to one another both in a limited bobble-head motion and also bobble-body motion that is akin to a waddle. The spring couplings also minimize unnatural appearance if the decoy is deployed out of vertical alignment. The spring mountings permit limited movement in rotation on the vertical axis, and also damp the extent of free motion permitted. The vertical post can be provided with a step section, and can be length extensible by selection of intermediate extension lengths to place the decoy body at an optimal height in grass or brush.

### CROSS REFERENCE TO RELATED APPLICATION

This application claims priority of U.S. provisional patent application Ser. No. 60/625,319, filed Nov. 5, 2004.

### FIELD OF THE INVENTION

The invention of this application concerns improved bird hunting decoys and supports for deployed decoys, and more particularly, to a decoy support structure that produces better movement and presentation of the decoy. A hunting decoy according to the present invention, for example, can be shaped and colored to represent a wild turkey. However, the invention of this application has much broader applications and should not be limited to hunting decoys.

The invention of this application relates to animal figurines that can be used as hunting decoys. Lindaman U.S. Pat. Nos. 6,216,382 and 6,481,147 disclose hunting decoys including a hollow decoy structure and a support stake structure and are hereby incorporated by reference for showing the same. Samaras U.S. Pat. No. 6,092,322 discloses a decoy with moving body parts and is also incorporated by reference herein for showing the same. Johnson U.S. Pat. No. 5,515,637 discloses a decoy in which the decoy body is mounted on a vertical stake and is also incorporated by reference herein for showing the same. Sroka U.S. Pat. No. 5,570,531 describes a bird decoy with motion associated with the decoy's head and neck and is also incorporated by reference herein for showing the same.

### BACKGROUND

Decoys are known in various shapes and colors to resemble specific animals, a familiar example being game birds. The decoys may be attractive to the corresponding species of game animal or to a different species, as a result of various instincts. These include (for example) social herding or similar safety-in-numbers instincts, predation or other expectation of finding food, opportunities for procreation, the urge to maintain territorial exclusivity, establishment of a place in a hierarchical pecking order, etc.

A decoy advantageously resembles a particular species accurately, at least as to attributes that a target species is inclined to notice. The decoy may be quite realistic, or may simply have critical attributes in common with the particular species it emulates, such as a comparable silhouette, color, movement, sound, odor, etc.

Decoys that appear realistic to humans are more popular among hunters than those that are obviously artificial. The target species may be prone to respond, positively or negatively, to the same aspects as humans, or possibly other aspects. Visually, many animals are highly sensitive to motion.

Visual mimicry is an important consideration, but not the only one. Decoys should be inexpensive to manufacture. The decoy should be compact or subject to packing in a manner that permits a hunter to carry a number of decoys into the field. The decoys should individually be very easy to deploy, quickly and silently, in any terrain that may be encountered, such as open grassland, woods or scrub vegetation.

U.S. Pat. No. 5,570,531 describes a bird decoy with motion associated with the head and neck. The decoy body is stationary. A one-piece head-and-neck portion is mounted to the body so that the head and neck may tilt when sufficient wind prevails. The decoy is helpful in that it moves, but it is not representative of a live animal, whose motion is unlikely to involve displacement of an integrally rigid head and neck relative to a rigid stationary body, even when the animal is standing in place.

U.S. Pat. No. 5,515,637 discloses a decoy in which the decoy body is mounted on a vertical journal axis by bearings. The idea is for ambient breeze to rotate the body on the vertical journal axis without substantial frictional resistance. The journal axis is set precisely vertical. The weight of the decoy is balanced evenly on opposite sides of the axis. The mounting comprises a helical spring which enables the breeze to wobble the decoy in the incident direction of the breeze. However, the pivot point of the device is not optional.

In a frictionless rotational mounting of such a type, it is also possible that the decoy body may turn one way or the other on the vertical axis, due to wind or another impetus. Turning on a vertical axis may appear natural in some conditions and therefore could be interesting to a game animal. However the wind speed and direction must catch the decoy body just right. If the wind is not at the particular speed and oriented in the specific direction that produces a convincing motion, the motion may be such that the decoy is caused to appear as an obvious fake. This problem is acute if there are several decoys deployed in a group. It might appear natural and interesting, for example, for decoys in a group occasionally to face in a new direction, for example as live animals in a group might face in unison toward the source of a sound. If decoys in a group rotate freely, a gust of wind could cause them to rotate in different directions and to continue beyond a full revolution. Such motion is mechanical and unrealistic.

If the rotation axis of a journal mounting is not at the center of mass, and the rotation axis is tilted relative to vertical, the decoy body will rotate preferentially to a stable rotational position at which the heaviest part of the decoy is at the lowest elevation. A gust of wind may act to rotate the body due to differences in surface area, for example exerting greater pressure on the thicker tail section than the thinner head section, causing a rotational force. This may rotationally displace the heaviest part of the decoy body from the angular position at which the heaviest part is at the lowest possible elevation. When the wind force subsides, the body tends to rotate back to the preferred orientation, because the heaviest part of the decoy body settles back at the preferred lowermost elevation. Typically, there is an associated rotational oscillation of a decreasing amplitude around the preferred rotational orientation, as the body settles back to the preferred orientation.

When deploying several decoys, particularly in a situation in which the decoys must be placed quickly and quietly before the hunter is spotted by the game, the hunter cannot take time to test and adjust the verticality of the rotation axes and the balance of the decoy bodies so as to face all the decoys in parallel or nearly parallel directions. Some of the ground stakes are likely to be set more near to vertical than others, which causes certain decoys in a group to be prone to rotate in the wind, while others do not. Even if care has been taken and the decoy bodies are all faced in parallel, balanced and aligned on vertical rotation axes, they may respond to a gust of wind by spinning around 360 degrees or more, possibly in different rotational directions, and may look obviously artificial.

A game animal is sensitive to motion and expects to see realistic motion in live animals. Suspicious unrealistic motion detracts from the effectiveness of the decoy. A group of decoy bodies that spin on their axes in a relatively uncontrolled and mechanical way, facing in random directions at any given time, and possibly spinning through more than 180 or even 360 degrees, is suspicious even if the static shape and color of the decoys are highly realistic.

### SUMMARY OF THE INVENTION

The present invention is applicable generally to visual decoys that are intended to approximate the appearance of a particular species. The decoys may represent any species and/or gender to which animals instinctively respond. A particularly demanding subject as well as a good demonstrative example is the American wild turkey.

Wild turkeys are wary animals with acute senses. Male turkeys are territorial and will challenge another male turkey in an established geographical range. Turkeys of either gender may approach other turkeys to establish dominance in a pecking order. Turkeys are large birds but they can fly a substantial distance and thus can very quickly move about in response to situations.

The invention is, therefore, described with reference to wild turkeys. However, the invention is also applicable to other particular species. For example,.the invention can be applied to decoys representing animals that frequent dry land or water, mammals or birds, prey animals or predators, etc. Further, the invention of this application can be used in connection with predator animals to prevent damage from unwanted wildlife or any other use associated with simulating wildlife.

In accordance with the present invention, a decoy support is provided which advantageously produces lifelike motion and which can be quickly adjusted to varied heights.

Further, the stake according to the present invention can include multiple points of movement simulating the movement of the particular animal without producing unlimited movement. Moreover, the decoy according to the present invention is easy to deploy and can be made to be compact for transporting several decoys. More particularly, the decoy in accordance with the present invention can include separate spring mounts between the body structure and the head structure to allow the body and the head to move relative to one another and minimize the likelihood of the decoy being out of balance.

In accordance with another aspect of the present invention, provided is a support structure that also allows the decoy to rotate about a vertical axis to create yet another degree of movement.

In accordance with a further aspect of the present invention, provided is a damping mechanism to help restrict the movement of the decoy body and the decoy head. The damping device can be, for example, a rubber or polymer sleeve coaxial to and covering the spring mechanisms. In another embodiment, the damping or homing of the moving parts relative to the other components can be achieved by the shaped relationship between the moving parts such as by detents in one or more of the components of the movement joints.

In accordance with even yet another aspect of the present invention, the degree of rotation of the decoy about the vertical axis can also be limited while allowing the movement described above.

In accordance with yet a further aspect of the present invention, provided is a support structure that can be used with existing decoys or new decoys that provides the described advantages.

These and other aspects of the invention will be apparent to those skilled in the art in view of the following discussion and the appended claims.

### BRIEF DESCRIPTION OF THE DRAWINGS

The foregoing will in part be obvious and in part be pointed out more fully hereinafter in connection with a written description of preferred embodiments of the present invention illustrated in the accompanying drawings in which:

FIG. 1 is an elevation view of a decoy stake according to the invention;

FIG. 1A is an side view of three differently sized intermediate rods;

FIG. 2 is an elevation view of another embodiment according to the invention having an anti-rotation feature;

FIG. 3 is a partial longitudinal sectional view of a decoy on a decoy stake assembly showing another embodiment of the present invention having a multiple support structure;

FIG. 4 is a sectional view taken along line 4-4 in FIG. 3;

FIG. 5 is a partial longitudinal sectional view of a decoy on a decoy stake assembly showing yet another embodiment of the present invention having a pivoting head mechanism;

FIG. 6 is a sectional view taken along line 6-6 in FIG. 5;

FIG. 7 is a partial longitudinal sectional view of a decoy on a decoy stake assembly showing yet a further embodiment of the present invention having a bent neck support arrangement;

FIG. 8 is a partial longitudinal sectional view of a decoy on a decoy stake assembly showing yet another embodiment of the present invention having a balanced bobbling head mechanism;

FIG. 9 is an exploded view of yet another embodiment of the invention of this application;

FIG. 10 is a partial longitudinal sectional view of yet even another embodiment of the present invention having an L-shaped neck support arrangement;

FIG. 11 is a partial longitudinal sectional view of a further embodiment of the present invention having a neck support which includes use of a strip spring arrangement;

FIG. 12 is a partial longitudinal sectional view of yet a further embodiment of the present invention having a neck support which also includes use of a strip spring arrangement;

FIG. 13 is an enlarged view of a spring steel strip shown in FIG. 12;

FIG. 14 is a partial longitudinal sectional view of yet a further embodiment of the present invention also having an anti-rotation feature;

FIG. 15 is an enlarged top view of another decoy mount according to another aspect of the present invention;

FIG. 16 is a side view of the decoy mount shown in FIG. 15;

FIG. 17 is an enlarged top view of yet another decoy mount according to yet another aspect of the present invention;

FIG. 18 is a side view of the decoy mount shown in FIG. 17;

FIG. 19 is an enlarged top view of a further decoy mount according to a further aspect of the present invention;

FIG. 20 is a side view of the decoy mount shown in FIG. 19;

FIG. 21 is an enlarged top view of yet even a further decoy mount according to another aspect of the present invention; and,

FIG. 22 is a side view of the decoy mount shown in FIG. 21.

### DETAILED DESCRIPTION OF PREFERRED EMBODIMENTS

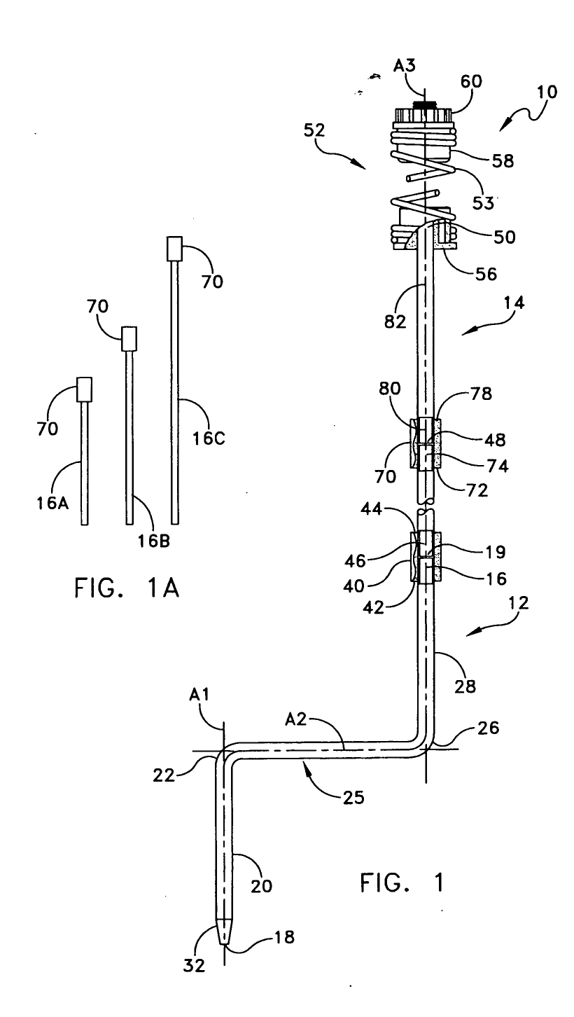

Referring now in greater detail to the drawings wherein the showings are for the purpose of illustrating preferred embodiments of the invention only, and not for the purpose of limiting the invention, FIG. 1 illustrates a hunting decoy stake 10 assembly according to an aspect of the invention. Stake 10 includes a ground portion 12, a support portion 14, and one or more intermediate rods 16 extendable between portions 12 and 14. Ground portion 12 extends between a bottom end 18 and a top end 19 and includes a lower, generally vertical section 20 adjacent bottom end 18 that is coaxial to axis A1, a first 90 degree bend 22, a generally horizontal mid-section 25 coaxial to axis A2, a second 90 degree bend 26 and an upper section 28 adjacent top end 19 and which is coaxial to axis A3. Bottom end 18 can include a conical end portion 32 to help the stake enter the ground.

The support forms a generally vertical post with a right angle bend on which one can step. It is preferred to have 90 degree bends 22 and 26, which 90 degree bends create a generally horizontal mid-section 25 that can provide a step at which the end user can apply foot pressure to force the stake into the ground. The 90 degree bends could be omitted if the stake was to be embedded by hand. As can be appreciated, and in alternative embodiments, bends 22 and 26 can be non-ninety degree angles, for example be less than 90 degrees which also produces a mid section that can be used to force the stake into the ground. Among other alternatives, a tee-shaped extension rung can be provided (not shown) or a step can be formed with a right angle, an acute outer elbow and an obtuse angle. This mid section arrangement as described can allow the decoy to rotate about lower section 20 based on the direction of the wind if the user maintains mid section 25 above the ground.

Top end 19 is shaped to receive one or more intermediate rods based on the particular application. As can be appreciated, the spacing between the ground and the decoy will be dependent on the natural surroundings. Decoys used in tall grass advantageously should be spaced further from the ground than decoys used in short grass if the decoy is to be easily seen. End 19 can include a sleeve 40 to allow attachment of intermediate rods 16, however, other fasteners known in the art could be used without detracting from the invention of this application. Sleeve 40 has a bottom opening 42 shaped to frictionally receive end 19 and a portion of upper section 28. Sleeve 40 further includes a top opening 44 shaped to frictionally receive a bottom portion 46 of intermediate rod 16. As can be appreciated, and with reference to FIG.1A, one or more intermediate rods can be used to change the overall height of stake 10 and/or rods 16 can be different lengths and come in varying lengths such as rods 16A, 16B and 16C. Further, rods, ground portion 12 and support portion 14 can be made from any material known in the art including, but not limited to, steels, stainless steels, plastics and composite materials.

Support portion 12 includes a bottom end 48 and a top end 50 wherein a spring assembly 52 can be joined thereto. Spring assembly 52 is preferably a coil spring 53, however, spring assembly 52 could utilize any biasing member that is capable of producing movement of the decoy relative to stake 10. Further, spring assembly 52 can include a biasing or damping element (not shown) to restrict or dampen the movement of the body relative to the shaft. Spring assembly 52 can further include a lower bushing 56 to secure the bottom of spring 54 to section 14 and an upper bushing 58 to secure a mount 60 to the top of the spring. Mount 60 can have many different configurations which will be discussed in greater detail below, however, FIG. 1 shows mount 60 having an upwardly extending threaded fastener 61 for securing the decoy to the stake with a similarly threaded nut 62. By utilizing a threaded fastener system, the decoy can be prevented from rotating about axis A3. However, the decoy could be placed on mount 60 without nut 62 if unwanted rotation is not an issue. As can be appreciated, while only one type of threaded fastener is shown, other types of fasteners could be utilized and even adhesives could be used. In addition, a bushing in the hole of the decoy body could also be used to reinforce the decoy body to prevent premature failure of the decoy body. As can be appreciated, it is advantageous to make the decoy body from a lightweight and even a collapsible material for easy transportation. However, these types of material do not always provide the structural integrity needed for a joint between two components.

Stake 10 further includes a second sleeve 70 that can be the same as sleeve 40 discussed above. Sleeve 70 also includes a bottom opening 72 shaped to frictionally receive a top portion 74 of intermediate rod 16 and a top opening 78 shaped to frictionally receive a bottom portion 80 of rod 82 that extends between bottom 80 and spring assembly 52. As can be appreciated, sleeves 40 and 70 do not need to be removable from both adjacent components. More particularly, and for example only, as is shown in FIG. 1A, sleeve 70 can be fixed to top end 74 of rod 16 and sleeve 40 can be fixed to top end 16 of ground section 12. Therefore, each rod 16 would include one end with a sleeve and the other end without a sleeve fastener. The top ends of both fasteners 40 and 70 would then be configured for selective engagement with the respective adjacent component.

In the following discussions concerning additional embodiments of the present invention, common components will be referred to with common reference numbers. Further, the following discussions that relate to changes to the support structure 14 discussed above, will not also discuss the bottom or intermediate structures. The discussion will be limited to the actual changes in the particular embodiment. However, while the majority of the changes in the respective embodiments are in the support portion, modifications can be made to the lower section, including but not limited to, changes in the height of the mid section, without detracting from the invention of this application.

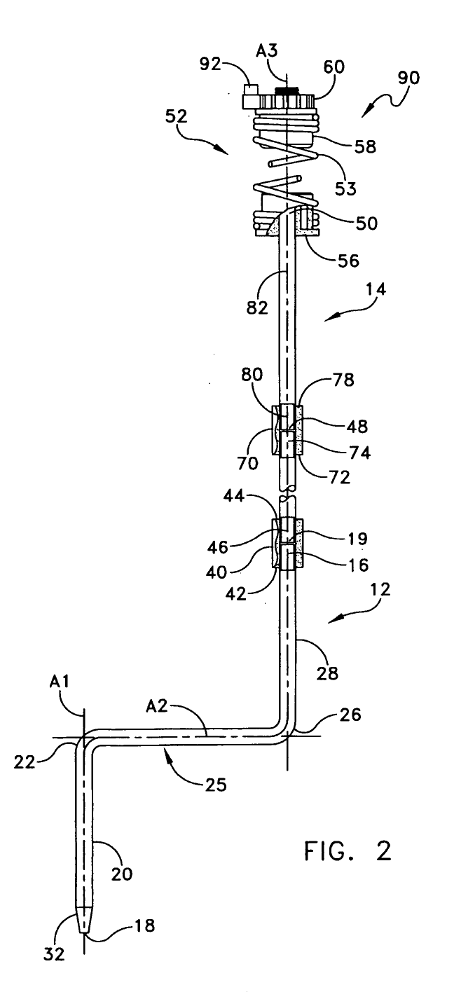

FIG. 2 shows a stake 90 which further includes an anti-rotation implement 92 that can be joined to mount 60 and/or be an extension of mount 60. Implement 92 is spaced from axis A3 and is sized and shaped to extend through a hole (not shown) in the decoy body (also not shown). By being spaced from axis A3, implement 92 prevents the decoy body from rotating about axis A3. As can be appreciated, the hole or opening in the decoy body could also be elongated to allow restricted rotation about axis A3 to allow limited rotational movement of the decoy.

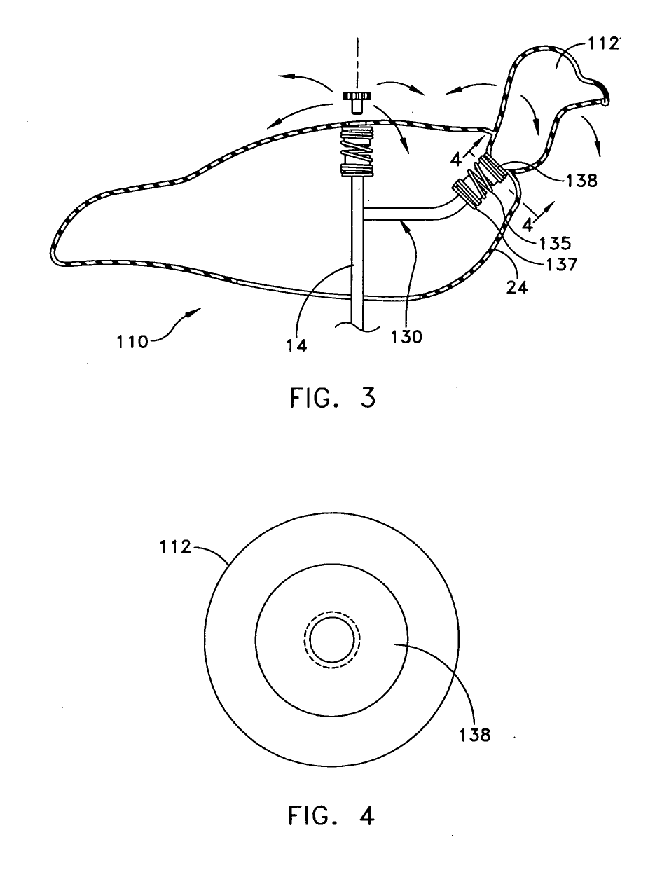

FIGS. 3 and 4 show yet another embodiment of the present invention. As can be appreciated, while not shown, this embodiment, as with the other embodiments of the present invention, can include other variations described above and below. More particularly, these figures show a decoy 110 having a decoy body 24 and a head 112. In this embodiment, stake section 14 further includes a forward shaft section 130 that is curved upwardly for, use with wildlife having a more upright head position. More particularly, shaft section 130 has a generally horizontal section 132 and an upwardly extending section 134 wherein section 134 has an end 137. A spring assembly 135 is joined to end 137 in the same fashion as described above and is mounted to head 112 by joint 138. As is also shown, the fastening system to secure the stake to the decoy body can include a threaded hole in mount 60 and a fastener 140. As can be appreciated, other mounting arrangements known in the art could also be used to secure the decoy body to the stake.

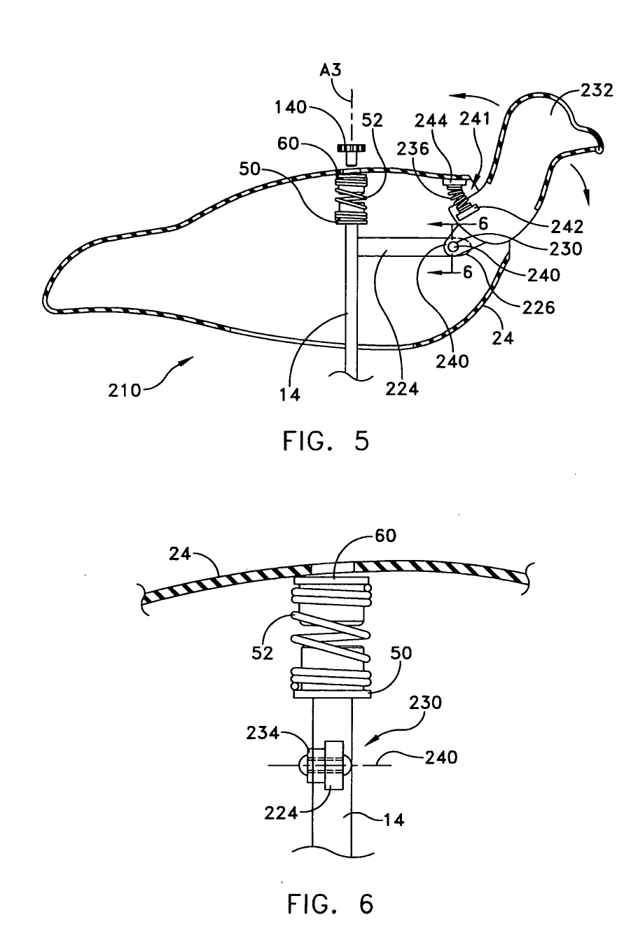

FIGS. 5 and 6 show yet another embodiment of the present invention. In this respect, shown is decoy 210 wherein stake section 14 further includes a forward section 224. Forward section 224 has an end 226 having a first portion of a pivot joint 230. Decoy 210 further includes a head 232 having a base 234 which includes a second portion of pivot joint 230. Pivot 230 allows head 232 to move about an axis 240 relative to stake section 224. While, as with other components, wind is utilized to create the body motion of the decoy, head 232 includes a centering device 241 to maintain the head at a natural central position and to ensure that the head returns to this central or home position. The particular embodiment produces a pecking motion. Further, as is shown, head 232 is also influenced by the movement of the body. In this respect, centering device 241 can be joined to body 24 thereby being influenced by the motion of body 24. While not shown, the centering device could also be jointed to the stake and/or incorporated into pivot 230. Centering device 241 includes a mount 242 connected to head 232, a mount 244 connected to body 24 and a biasing member 236. As with other embodiments, while member 236 can be a spring, other flexible devices and/or materials can be utilized without detracting from the invention.

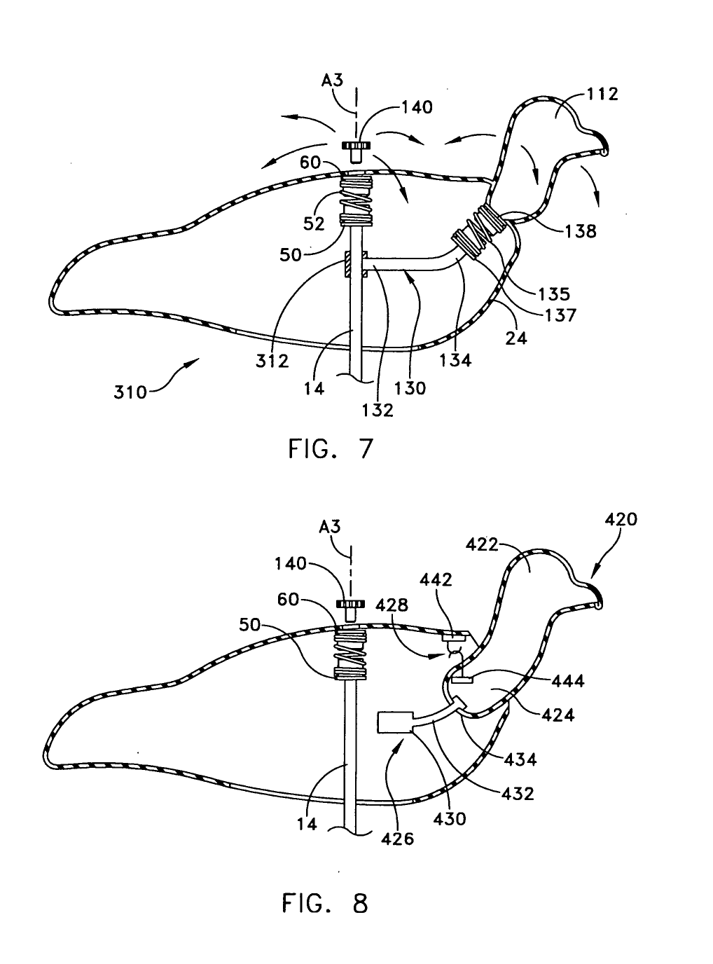

FIG. 7 shows yet another embodiment of the invention of this application. More particularly, shown is a decoy 310 having a configuration similar to the one shown in FIGS. 3 and 4, however, forward section 130 is selectively connectable to stake section 14 by connector 312. This configuration allows the stake to be used with multiple decoy structures including those with or without special head movement arrangements.

However, as is shown in FIG. 8, head mechanisms can be independent of the stake. More particularly, shown is a decoy 410 with stake 10 and a bobble-head 420. While decoy 410 is shown with stake 10, as is stated above with respect to other embodiments, other stake or base configurations can be utilized in this embodiment. With respect to the head mechanism, bobble-head 420 is also influenced by wind, however, bobble-head 420 is separate from stake 10. More particularly, bobble-head 420 includes a head 422, a neck 424, a weight system 426 and a hanging system 428. Hanging system 428 retains bobble-head 420 relative to body 24 and weight system 426 helps control the bobbling action of bobble-head 420. Neck 424 provides a more realistic look for the decoy. Weight system 426 includes a weight 430 that can be directly attached to head 422 and/or neck 424 or can be spaced from head 422 and/or neck 424 by a weight arm 432. As can be appreciated, based on the weight of head 424 and the desired position of hanging system 428 and head 424, it may be necessary to space the weight from the head to achieve a desired neutral head position (the position the head will return to when external forces are removed). Arm 432 it attached to neck end 434. As can be appreciated, neck 424 could also be extended to act as weight 430 and/or arm 432. With respect, to hanging system 428, included is a body hanger 442 and a head hanger 444. Body hanger 442 is attached to body 24 and head hanger 444 is connected bobble-head 420 at a balanced position wherein bobble-head 420 is held in a desired position relative to body 24. While hangers 442 and 444 are shown to be hooks, any known hanging mechanism could be used which produces the desired head movement including, but not limited to, a hook and a loop, two loops and even a flexible strap. In addition, hanging system 428 could also be supported by a forwardly extending section of the support structure or stake (not shown).

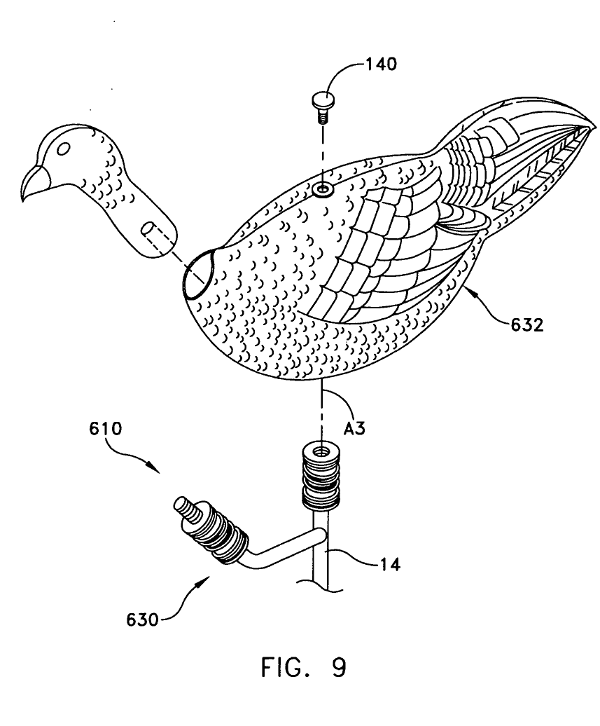

FIG. 9 shows yet a further embodiment of the invention of this application. More particularly, shown is a decoy 610 wherein stake section 14 includes an angled support arm 630 which, besides its angled configuration, is structured the same as above and, therefore, will not be discussed in detail. Further shown is that the stakes of this application can be easily disassembled from the decoy for compact storage and easy transportation. In this respect, the stake can be used with a decoy having a collapsible decoy body 632 such that body 632 and head 72 can be easily removed from the stake and stored compactly for transportation and/or storage. Again, as is emphasized above, these features can be utilized in other embodiments such that any of the above described decoys can utilize collapsible decoy body 632.

FIG. 10 shows yet a further embodiment of the invention of this application. More particularly, shown is a decoy 710 wherein stake section 14 further includes an L-shaped mounting arm 630 with a spring 632 on the end of arm 630 with a spring mount 634. A fastener 636 can be used to secure head 72 to the spring mount.

FIG. 11 shows even yet a, further embodiment of the invention of this application. More particularly, shown is a decoy 710 wherein stake section 14 includes a mounting arm 730 with a slot 732. Slot 732 is shaped to receive a spring steel strip 734 that produces, at least in part, the motion of head 112 relative to the body. In this respect, the inter-engagement between strip 734 and slot 732 allows limited rotation of spring strip 734 about an axis 736. As can be appreciated, forward section 730 can also be selectively attachable to section 14, as with the other embodiments of this application. FIGS. 12 & 13 show another attaching method for spring steel strip 734. More particularly, arm 730 can include a nipple 740 and strip 734 can include a mounting hole 742 for attaching strip 734 to the stake. A fastener 744 can be used to secure the strip to the nipple. As with the embodiment shown in FIG. 11, head and spring, strip 734 can rotate about axis 736 while the spring steel produces wobbling motions. As can be appreciated, other joining methods can be used for connecting the spring steel.

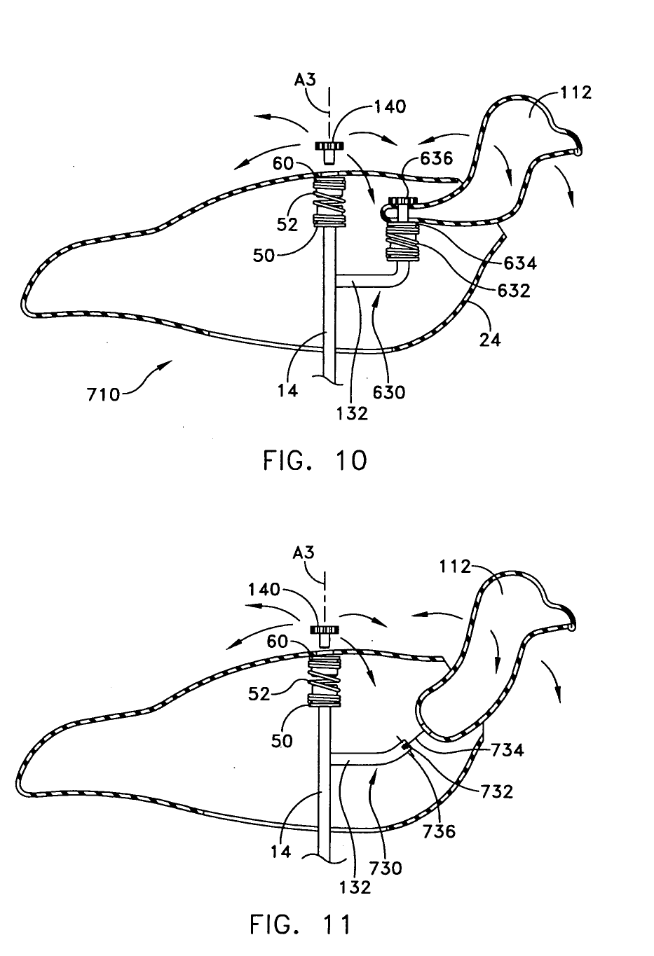

FIG. 14 shows even yet another embodiment of the invention of this application. More particularly, shown is a decoy 810 wherein stake section 14 includes a forward extending section 812 and an anti-rotation feature. In this respect, stake mount 822 can be configured to pass through a hole 830 in decoy body 832 similar to the decoys and stakes described above. However, in addition, mount 822 can include an anti-rotation feature such as an- anti-rotation arm 824 extending from mount 822. Arm 824 is L-shaped and extends through a second hole 826 in decoy body 832 when the decoy body is in the mounted condition. As can be appreciated, this configuration can be used to prevent the decoy body from rotating relative to the stake. As can be appreciated, the anti-rotation feature can include an upwardly extending anti-rotation implement extending from mount 822. Further, stake mount 822 can also include an elongated portion and hole 830 can have a corresponding elongated configuration such that the decoy body is prevented from rotating relative to the stake. If limited rotation is desired, hole 826 could be an arcuate slot thereby allowing arm 824 to move along the slot, however, this movement would be limited by the length of the slot. As is stated above and as with other embodiments, the anti-rotation feature of stake 820 can be used in connection with other embodiments of this application.

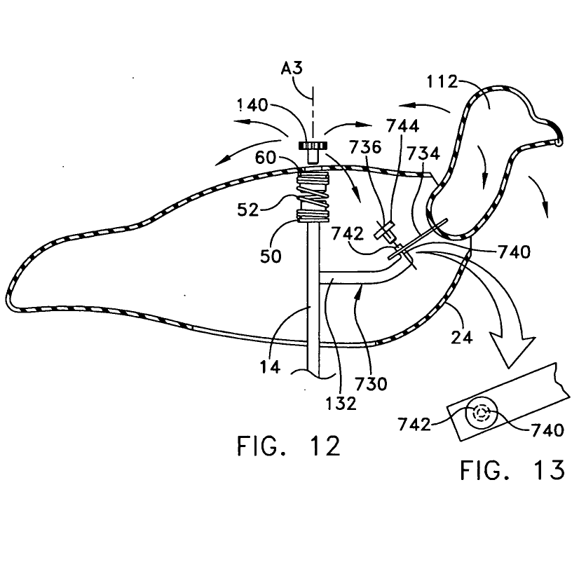

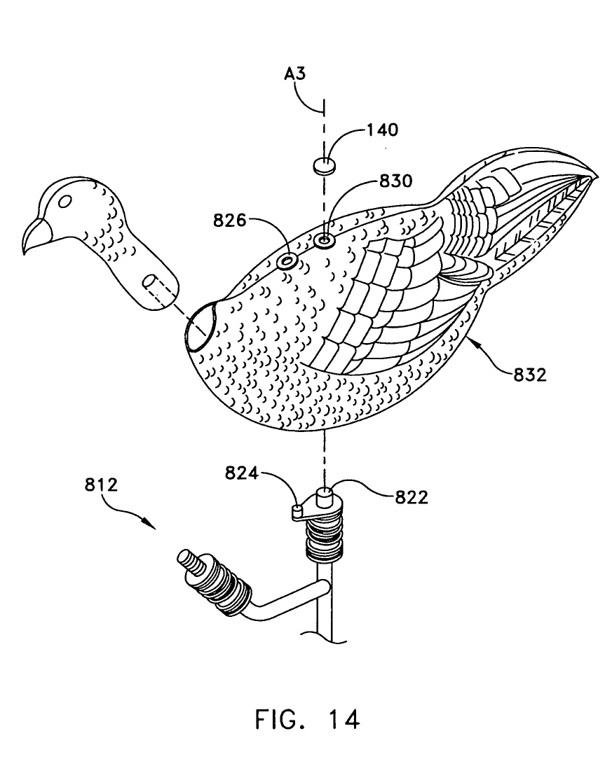

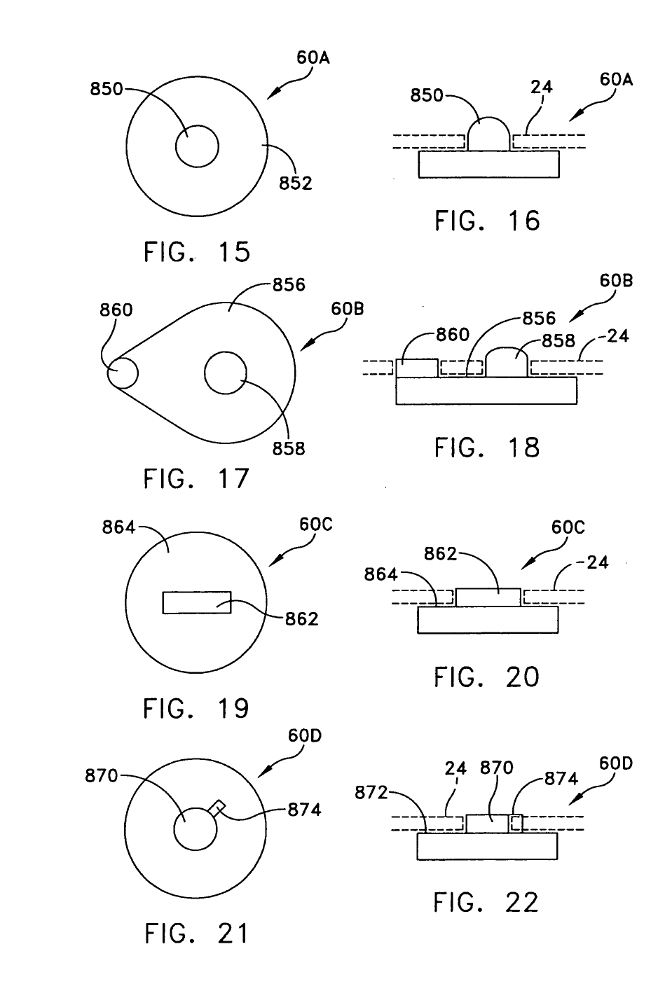

With reference to FIGS. 15-22, mount 60 can have many different configurations to produce a desired result. As is discussed above with respect to mount 60, the mount can include threaded shaft 61 such that nut 62 can be tightened down to secure the decoy body to the stake. Further, as is shown for example in FIG. 3, mount 60 can include a threaded opening and threaded fastener 140 could be used to secure the decoy body to the stake.

In addition, a mount 60A could be used which only includes an upwardly extending protrusion 850 and a generally flat base 852. The hole in the decoy body is then merely placed over protrusion 850. Further, a mount 60B could be used which includes a generally flat base 856 and a first upwardly extending protrusion 858 and a second upwardly extending protrusion 860. Protrusions 858 and 860 can be the same size or can be different sizes and can be used to prevent unwanted rotation without having to tightly thread a threaded fastener arrangement, Again, the decoy body, which includes two holes in the body, is merely placed on mount 60B and the weight of the body maintains the body on the stake. As can be appreciated, the second hole corresponding with protrusion 860 can be elongated to allow a restricted range of rotation about axis A3. Yet even further, a mount 60C could be used which includes an elongated protrusion 862 extending from surface 862 which mates with a corresponding elongated opening to prevent rotation. Protrusion 862 could be any polygonal configuration and could be any configuration that prevents rotation. Yet another mount 60D could be used which includes an upwardly extending protrusion 870 extending from surface 872 which includes a radially extending tab 874 that can also be used to prevent rotation without the need to rigidly secure the decoy body to the stake.

While considerable emphasis has been placed on the preferred embodiment of the invention illustrated and described herein; it will be appreciated that other embodiments can be made and that many changes can be made in the preferred embodiment without departing from the principles of the invention. Accordingly, it is to be distinctly understood that the foregoing descriptive matter is to be interpreted merely as illustrative of the invention and not as a limitation.

What is claimed is:

1. A decoy assembly comprising:
an animal decoy body;
a mounting mechanism for said animal decoy body including at least one elongated shaft for supporting at least a portion of the animal body;
a coupling affixing at least said portion of the animal decoy body to the at least one elongated shaft, the coupling permitting displacement of said portion of the animal decoy body relative to the shaft.

2. The decoy assembly of claim 1, wherein the elongated shaft includes at least one of a vertical post member for attachment at a dorsal back portion of the animal body and a divergent head support member for attachment at one of an animal head and neck.

3. The decoy assembly of claim 1, comprising a vertical post for attachment at a dorsal back portion of the animal body and a divergent head support member for attachment at one of an animal head and neck.

4. The decoy assembly of claim 3, wherein the elongated shaft comprises a joint at which successive lengths are affixed endwise to define a length of the elongated shaft.

5. The decoy assembly of claim 4, wherein the successive lengths are endwise affixed at detachably engaged male and female ends of respective ones of said lengths.

6. The decoy assembly of claim 5, further comprising at least one extension detachably mountable between the male and female ends of said respective ones of the lengths.

7. The decoy assembly of claim 5, wherein the extension is detachably mountable between endwise connected portions of the vertical post, and further comprising a plurality of extensions of different lengths that are selectable for detachable mounting individually or successively between the male and female ends of said respective ones of the lengths for adding to a height of the animal decoy body as carried on the vertical post.

8. The decoy assembly of claim 1, wherein the mounting mechanism comprises a lower part structured to be supported on the ground and an upper part carrying the coupling.

9. The decoy assembly of claim 8, wherein the lower part of the mounting mechanism comprises a ground insertable lower end and a substantially horizontal length dimensioned for a user to apply foot pressure for pressing said lower end into the ground.

10. The decoy assembly of claim 8, wherein the lower part of the mounting mechanism comprises a ground insertable lower end and the mounting mechanism includes a right angle with a substantially horizontal length by which a user can apply foot pressure for pressing said lower end into the ground.

11. The decoy assembly of claim 1, wherein the coupling affixing the animal decoy body to the elongated shaft comprises a flexible portion.

12. The decoy assembly of claim 1, wherein the coupling affixing the animal decoy body to the elongated shaft comprises a cylindrical spring permitting flexing of the animal decoy body over a range of angles radial to the elongated shaft.

13. The decoy assembly of claim 12, wherein the coupling affixing the animal decoy body to the elongated shaft comprises a helical spring on a longitudinal axis parallel to the vertical post.

14. The decoy assembly of claim 12, wherein the coupling affixing the animal decoy body to the elongated shaft comprises a helical spring on an axis parallel to a diverging member carrying a head of the animal decoy body.

15. The decoy assembly of claim 1, wherein the coupling affixing the animal decoy body to the elongated shaft comprises a helical spring having a lower end affixed substantially non-rotatably at a bottom spool to the vertical post and at a top spool affixed to the animal decoy body.

16. The decoy assembly of claims 15, wherein the animal decoy body has a hollow torso and a dorsal wall portion, wherein the dorsal wall portion is attached to the top spool.

17. The decoy assembly of claim 16, wherein the dorsal portion of the decoy body has a hole for receiving a fastener passing through the dorsal wall portion into the top spool.

18. The decoy assembly of claim 17, wherein the dorsal portion of the decoy body has at least two holes, at least one of which is eccentric to the vertical post and is rotationally affixed to said top spool.

19. The decoy assembly of claim 16, wherein the dorsal wall portion of the decoy body includes a center connection to the top spool along the vertical axis and an eccentric connection to the top spool, at least one of the center connection and the eccentric connection including a fastener passing through the dorsal wall portion of the decoy body.

20. The decoy assembly of claim 1, wherein the decoy body is simulative of a game fowl.
